(19) United States
(12) Patent Application Publication
(10) Pub. No.: US 2016/0253154 A1
(43) Pub. Date: Sep. 1, 2016

(54) Square to circle software

(71) Applicant: Michael Lewis Moravitz, Fairfax, VA (US)

(72) Inventor: Michael Lewis Moravitz, Fairfax, VA (US)

(21) Appl. No.: 14/999,154

(22) Filed: Apr. 4, 2016

(51) Int. Cl. G06F 9/44

(52) U.S. Cl. CPC G06F 8/10

(57) ABSTRACT

Instead of calculating pi, perhaps software can be developed in which a square becomes a circle, yielding a precise circumference and clues to new formulae, perhaps using different numeric systems.

Software can be developed in which a square (or rectangle)—which has a definite and easily calculated diameter—could be changed into a circle—perhaps yielding a definite number for the circumference. This would also provide clues to a better equation or even one with a precise answer that would not use pi.

I suggested in my patent application for sub-integer engineering that a different numeric system might be used for an equation to calculate the circumference of a circle, the area of a circle, the volume of a sphere, the surface area of a sphere, and for formulae for other geometric, mathematical, and statistical uses. Pi has been calculated beyond a trillion decimal points, but that is of little use to engineers. A precise formula for circumference and for the other uses would lead to cost efficiencies in engineering as well as reduce product breakdowns through imprecision. Perhaps the super-computers stop whirring to find the possible endpoint of pi, and a search using computer software to “circle the square” or to find new formulae would be mounted instead by top software developers and mathematicians.

1) Builds on software for geometric patterns; and

2) My previous patent application for Sub-Integer Engineering (29/463,837).
